(19) United States
(12) Patent Application Publication
(10) Pub. No.: US 2013/0216842 A1
(43) Pub. Date: Aug. 22, 2013

(54) METHOD OF BONDING CERAMIC AND METAL AND BONDED STRUCTURE OF CERAMIC AND METAL

(71) Applicant: DENSO CORPORATION, (US)

(72) Inventors: Yasunori KAWAMOTO, Nagoya-shi (JP); Yasuyuki OOKOUCHI, Toyota-shi (JP)

(73) Assignee: DENSO CORPORATION, Kariya-city (JP)

(21) Appl. No.: 13/767,297

(22) Filed: Feb. 14, 2013

(30) Foreign Application Priority Data
Feb. 20, 2012 (JP) 2012-033882

(51) Int. Cl. B23K 31/02

(52) U.S. Cl. CPC B23K 31/02
USPC 428/450; 228/124.1

(57) ABSTRACT

The present invention provides a method of bonding ceramic and metal comprising the steps of bonding metal foils to a bonding surface of a ceramic matrix and a bonding surface of a metal matrix to be bonded and then heating so as to leave metal layers at the surfaces of the metal foils while forming diffusion layers with inclined linear expansion coefficients with materials of the metal foils diffused in them between the ceramic matrix and metal layer and between the metal matrix and metal layer, and making the respective metal layers which remain at the surfaces of the metal foils bond so as to bond the ceramic matrix and the metal matrix.

### BACKGROUND ART

The present invention relates to a method of bonding ceramic and metal and a bonded structure of ceramic and metal which give diffusion layers with inclined linear expansion coefficients which are suitable for bonding a hydrocarbon-based ceramic forming the material of a catalyst or thermistor which is used in a high heat resistant environment with a high heat resistant alloy for obtaining electrical conduction.

Ceramics are generally excellent in wear resistance, heat resistance, corrosion resistance, etc. and are being widely used in mechanical parts, electronic parts, etc. However, ceramics are difficult to shape and work into complicated shapes, so the practice is to shape and work a metal which is easy to shape and work and bond a ceramic to the obtained part so as to obtain the desired part.

As a typical method of bonding a ceramic and metal, there is brazing. However, the brazing material which is used for the brazing method is limited in usage temperature from the viewpoint of the creep resistance under a high temperature environment.

In recent years, in the bonding of a ceramic and metal which are used for auto parts, for example, bonding able to withstand use under a 500 to 900° C. or so environment is desired for use for a part which is mounted in exhaust gas. To realize such bonding, rather than using a low melting point brazing material for the bonding layer, there is the method of forming a diffusion layer between the ceramic and metal so as to make the bonded part higher in melting point and raise the heat resistance.

However, even if a diffusion layer can be formed, there is the problem that under a high temperature environment, the tensile stress which is caused at the time of a high temperature due to the difference between the ceramic and metal in linear expansion coefficient causes the bonded part or the ceramic to break.

Japanese Patent Publication No. 63-144175 A1 discloses a bonded structure of ceramic and metal which interposes three types of metal between the ceramic and metal and bonds them by diffusion bonding so as to lower the residual stress due to the difference of linear expansion coefficient.

However, in the bonded structure of PLT 1 as well, there is a difference among the ceramic, metal, and interposed metals in linear expansion coefficient, so the strength against tensile stress which is caused at the time of a high temperature was insufficient.

### CITATIONS LIST

### Patent Literature

PLT 1. Japanese Patent Publication No. 63-144175 A1

### SUMMARY OF INVENTION

The present invention was made in consideration of the above situation and has as its object to provide a method of bonding ceramic and metal which is free from breakage by tensile stress which is caused by the difference between a ceramic and metal in linear expansion coefficient even under a high temperature environment.

The inventors engaged in intensive studies regarding a bonded structure of ceramic and metal which is free from breakage by tensile stress which is caused by the difference between ceramic and metal in linear expansion coefficient even under a high temperature environment.

As a result, they discovered that by bonding high melting point metal foils with the ceramic and metal to be bonded and then heating while forming a temperature gradient so as to form diffusion layers with an inclined linear expansion coefficient, it becomes possible to obtain a bond of ceramic and metal which can withstand even a high temperature environment.

The method of bonding ceramic and metal of the present invention is based on the above knowledge and comprises a step of bonding metal foils to a bonding surface of a ceramic matrix and a bonding surface of a metal matrix to be bonded and then heating so as to leave metal layers at the surfaces of the metal foils while forming diffusion layers with inclined linear expansion coefficients with materials of the metal foils diffused in them between the ceramic matrix and metal layer and between the metal matrix and metal layer and a step of making the respective metal layers which remain at the surfaces of the metal foils bond so as to bond the ceramic matrix and the metal matrix.

According to the present invention, it is possible to bond a ceramic and metal which have diffusion layers with inclined linear expansion coefficients and give a bond of ceramic and metal which can withstand even a high temperature environment.

### BRIEF DESCRIPTION OF DRAWINGS

These and other objects and features of the present invention will become clearer from the following description of the preferred embodiments given with reference to the attached drawings, wherein:

FIG. 1 is a view which schematically shows a ceramic matrix and metal matrix at which diffusion layers are formed in a method of bonding a ceramic and metal of the present invention.

FIG. 2 is a view which schematically shows a linear expansion coefficient of a bonded structure of ceramic and metal of the present invention.

FIGS. 3A and 3B are view which schematically show a method of heating a ceramic matrix and a metal matrix to which metal foils are bonded by induction heating in a method of bonding a ceramic and metal of the present invention.

FIG. 4 is a view which schematically shows a method of heating a ceramic matrix and a metal matrix to which metal foils are bonded by laser heating in a method of bonding a ceramic and metal of the present invention.

FIG. 5 is a view which schematically shows a ceramic matrix and metal matrix at which diffusion layers are formed in a method of bonding a ceramic and metal of the present invention.

### DESCRIPTION OF PREFERRED EMBODIMENTS

Below, the present invention will be explained more specifically while referring to the drawings.

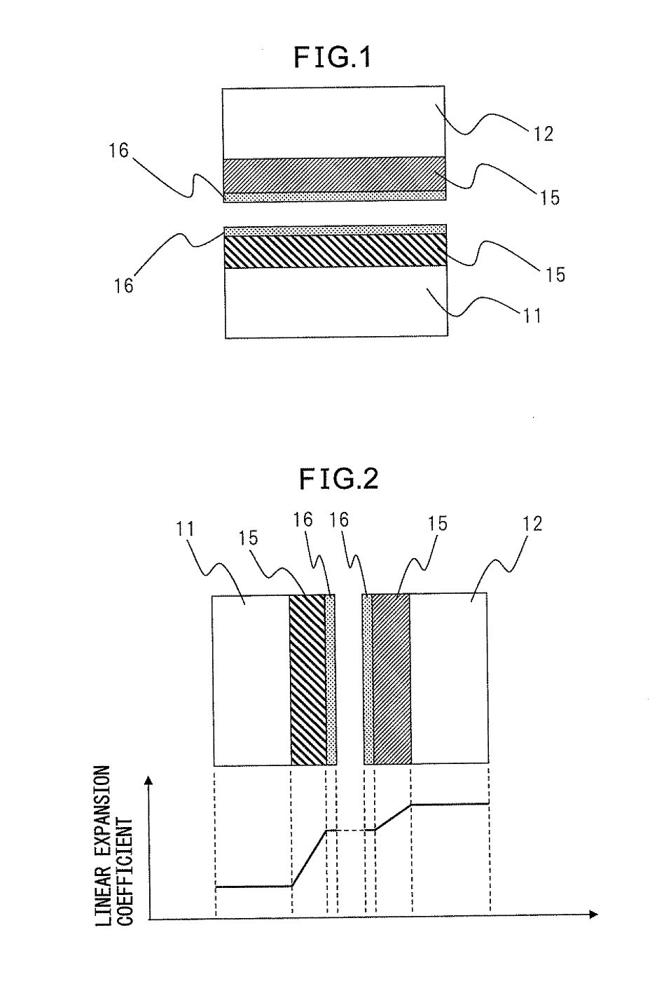

In the method of bonding ceramic and metal of the present invention, first, as shown in FIG. 1, by bonding metal foils to the bonding surface of the ceramic matrix and the bonding surface of the metal matrix to be bonded then heating, diffusion layers with inclined linear expansion coefficients are formed while leaving metal layers at the surfaces of the metal foils.

Here, “inclination” of a linear expansion coefficient means a monotonic change of the linear expansion coefficient. That is, as shown in FIG. 2, the linear expansion coefficient increases monotonically from the metal matrix toward the metal layer at which the metal foil remains and, further, monotonically increases from the other metal layer toward the ceramic matrix. At this time, the change of the linear expansion coefficient is preferably a certain gradient, but is not necessarily constant.

The thickness of the diffusion layers is preferably 1 to 100 μm. If the thickness of the diffusion layers is less than 1 μm, securing a sufficient bond strength becomes difficult. Further, even if the thickness of the diffusion layers is over 100 μm, the increase in bond strength becomes saturated. This becomes disadvantageous in terms of the manufacturing costs.

For bonding the metal foils, it is possible to use welding, diffusion bonding, seal bonding, bonding by pressing, or another method.

The ceramic matrix and metal matrix to which metal foils are bonded may be heated by separate vacuum furnaces. Alternatively, the method of utilizing a temperature difference so as to form a temperature gradient may also be used. As specific examples of utilizing a temperature difference, induction heating, laser heating, arc plasma, resistance heating, heating by an electron beam, etc. may be mentioned.

In the case of using a method which utilizes a temperature difference, it is possible to use a single apparatus enabling formation of a temperature gradient to simultaneously heat the ceramic matrix and metal matrix to which metal foils are bonded.

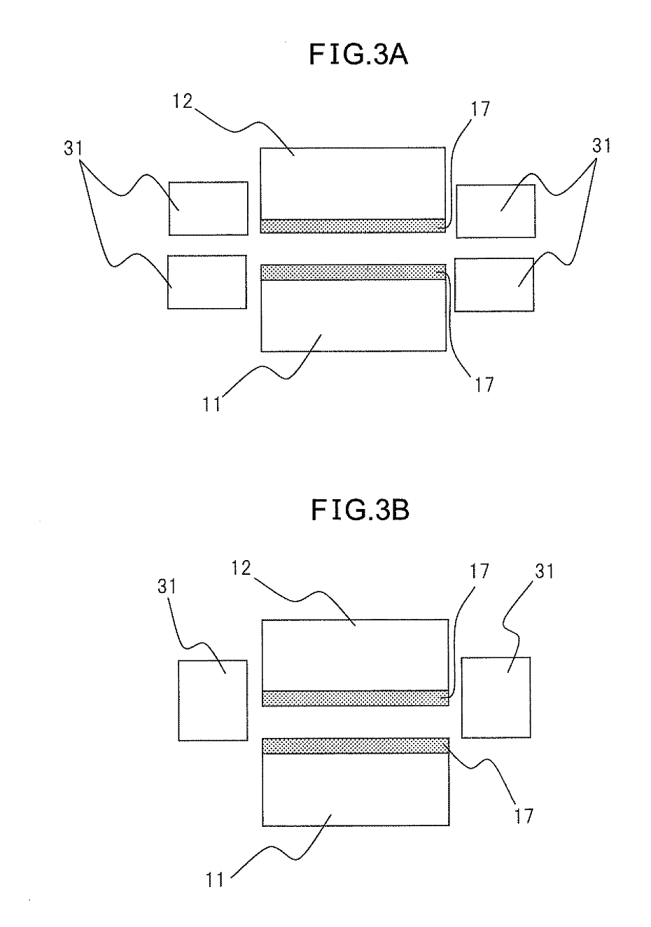

As a method based on induction heating, for example, the method as shown in FIG. 3A of placing coils at the locations to be heated and making the currents and frequencies run to the coils differ to form a temperature gradient and the method as shown in FIG. 3B of performing induction heating at the metal matrix (12) side and using that radiant heat to raise the temperature of the ceramic matrix (11) side may be used.

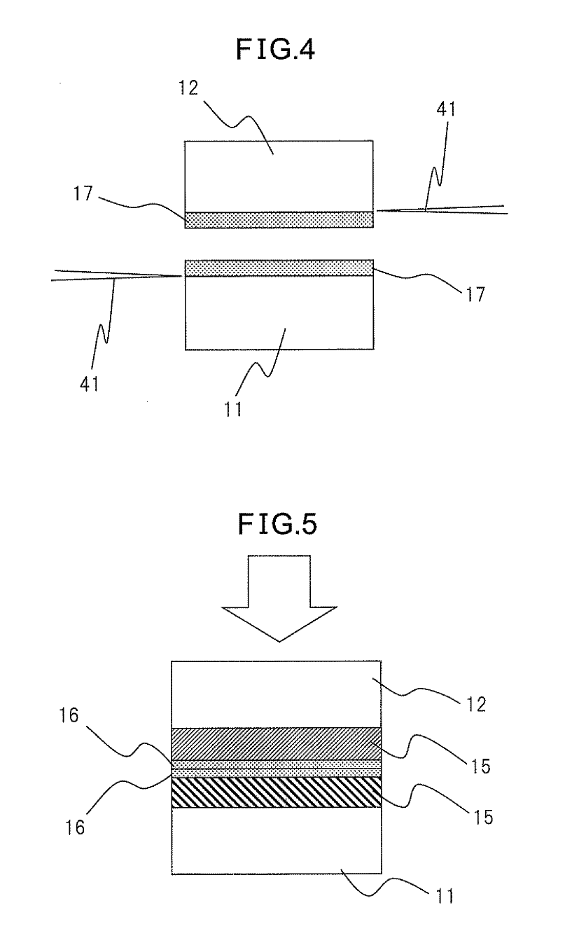

As a method using laser heating, as shown in FIG. 4, by firing different powers of lasers at the bonding interface of the ceramic matrix (11) and the metal foil (17) and the bonding interface of the metal matrix (12) and the metal foil (17), it is possible to form a temperature gradient.

With heating by arc plasma, by arranging a metal matrix and ceramic matrix to which metal foils are bonded at locations where plasma is generated and utilizing the fact that the temperature differs by the distance, it is possible to form a temperature gradient.

In the case of resistance heating, the heat generated by contact resistance in the case of conduction in the state with the metal foil contacting the workpiece is utilized.

In either case, when the temperature distribution of the bonding surfaces is not uniform, it is possible to make use of the features of the heating methods for heating to realize a bond.

As the ceramic material to which the bonding method of the present invention can be applied, for example, a material comprised of SiC to which Si has been added and having electrical conductivity can be used. This invention can also be applied to another nonoxide-type ceramic or to an oxide-type ceramic.

The metal material need only be a heat resistant alloy which can be used under a high temperature environment. Stainless steel and Inconel® are typical examples.

The metal foil which is bonded to the ceramic matrix may be a material which can diffuse in a ceramic matrix. For example, Cr can be used as the metal foil when the ceramic matrix is comprised of SiC to which Si is added.

The metal foil which bonds with the metal matrix is similarly a material which can diffuse in a metal matrix. For example, Cr can be used when the metal matrix is Inconel®.

The metal foil which bonds to the ceramic matrix and the metal foil which bonds to the metal matrix do not have to be comprised of the same metal material, but being comprised of the same metal material is advantageous from the viewpoint of the bond strength.

The ceramic matrix and metal matrix to which metal foils are bonded are heated to the optimal temperatures considering diffusion of the metal foils to the materials.

For example, when bonding a Cr foil to SiC to which Si is added, heating at 900 to 1300° C. is suitable for diffusion of Cr. When bonding a Cr foil with Inconel®, heating at 1200° C. or more is suitable for diffusion of Cr.

By using the above-mentioned methods to heat the ceramic matrix and metal matrix at their optimal temperatures, it is possible to form diffusion layers with inclined linear expansion coefficients.

When bonding a Cr foil to SiC to which Si is added and heating then, the Cr diffuses while reacting with the SiC or Si so as to form CrSi, CrC, or another alloy and form a diffusion layer with an inclined linear expansion coefficient.

When bonding a Cr foil to Inconel® and heating them, Cr diffuses in the matrix, whereby a diffusion layer with an inclined linear expansion coefficient is formed.

When forming these diffusion layers, the metal layers remaining from the metal foils are exposed at the surfaces of the metal foils. By metal layers being exposed at the surfaces, heating or pressing may be used to bond the ceramic matrix and the metal matrix where the diffusion layers are formed.

In bonding a ceramic matrix and a metal matrix, changing the conditions of the above-mentioned heat source is effective. Further, by pressing and creating a newly formed surface of metal, it becomes possible to efficiently performing bonding by metal bonding (FIG. 5).

The ceramic matrix and the metal matrix may be bonded after the above-mentioned diffusion layers finish being formed or while the diffusion layers are being formed.

Further, as a method of utilizing a temperature difference, it is effective to put together materials for which diffusion is desired at a high temperature and bond them at a high temperature, then put together the bonded metal foil side and the materials for which diffusion is desired at a low temperature and bond them at a low temperature. In this case, the process of bonding metal foils becomes unnecessary.

When using the method of the present invention to bond SiC and Inconel® to which Cr foils are bonded, a diffusion layer with an inclined linear expansion coefficient of an average 7×10⁻⁶/° C. is formed between the SiC with a linear expansion coefficient of 5×10⁻⁶/° C. and the Cr metal layer with a linear expansion coefficient of 8×10⁻⁶/° C. Further, a diffusion layer with an inclined linear expansion coefficient of an average 10×10⁻⁶/° C. is formed between the Cr metal layer and Inconel® with a linear expansion coefficient of 13×10⁻⁶/° C. The linear expansion coefficient depends on the ratio of Cr, so can be freely set from the amount of diffusion of Cr. Even when using a metal foil other than Cr, similar design is possible.

As explained above, a layer with a linear expansion coefficient which continuously inclines is formed between the SiC and Inconel®, so it is possible to realize a strength by which SiC does not break due to the tensile stress which is generated at the time of a high temperature even under a high temperature environment.

The example which is explained above is just one example. Even when using another ceramic or metal, it is possible to design the thickness of the diffusion layer or linear expansion coefficient for preventing breakage of the ceramic or metal by structural analysis etc. and apply the present invention.

The bonded structure of ceramic and metal of the present invention is suitable for bonding a hydrocarbon-based ceramic forming a material for a catalyst or thermistor which is used in a high heat resistant environment and a high heat resistance alloy for obtaining electric conduction (stainless steel, Ni steel, etc.)

While the invention has been described by reference to specific embodiments chosen for purposes of illustration, it should be apparent that numerous modifications could be made thereto by those skulled in the art without departing from the basic concept and scope of the invention.

1. A method of bonding ceramic and metal comprising the steps of:
bonding metal foils to a bonding surface of a ceramic matrix and a bonding surface of a metal matrix to be bonded and then heating so as to leave metal layers at the surfaces of the metal foils while forming diffusion layers with inclined linear expansion coefficients with materials of the metal foils diffused in them between the ceramic matrix and metal layer and between the metal matrix and metal layer; and
making the respective metal layers which remain at the surfaces of the metal foils bond so as to bond the ceramic matrix and the metal matrix.

2. The method of bonding ceramic and metal as set forth in claim 1 wherein the heating of the ceramic matrix and the heating of the metal matrix are performed at different temperatures.

3. The method of bonding ceramic and metal as set forth in claim 1 wherein the heating of the ceramic matrix and the heating of the metal matrix are performed simultaneously using the same apparatus able to cause a temperature gradient.

4. The method of bonding ceramic and metal as set forth in claim 1 wherein the heating of the ceramic matrix and the heating of the metal matrix are performed using different furnaces.

5. The method of bonding ceramic and metal as set forth in claim as set forth in claim 1 wherein the metal foil which is bonded with the bonding surface of the ceramic matrix and the metal foil which is bonded with the bonding surface of the metal matrix are comprised of the same metal material.

6. A bonded structure of ceramic and metal, the bonded structure of ceramic and metal having, between that ceramic and metal, diffusion layers with an inclined linear expansion coefficient.
